(19) United States
(12) Patent Application Publication
(10) Pub. No.: US 2025/0126660 A1
(43) Pub. Date: Apr. 17, 2025

(54) METHOD FOR UNLOCKING A FUNCTION ON A DEVICE, AN UNLOCKING NETWORK FOR IMPLEMENTING THE METHOD, AND A COMPUTER PROGRAM

(71) Applicant: Robert Bosch GmbH, Stuttgart (DE)

(72) Inventors: Josef Novak, Zwiesel (DE); Florian Maier, Straubing (DE); Thomas Koppera, Zachenberg (DE)

(21) Appl. No.: 18/910,159

(22) Filed: Oct. 9, 2024

(30) Foreign Application Priority Data
Oct. 13, 2023 (DE) 10 2023 210 065.7

(51) Int. Cl. H04W 76/10; H04W 4/80; H04W 8/22

(52) U.S. Cl. CPC H04W 76/10; H04W 4/80; H04W 8/22

(57) ABSTRACT

A method for unlocking a function on a device, wherein an intermediate device comprising an unlocking arrangement uses a first communication link for communication, wherein the intermediate device comprising the device uses a second communication link for communication, wherein the device comprising the unlocking arrangement exchanges unlocking communication data via the first and second communication link so that the function on device is enabled, wherein the second communication link is achieved via an NFC interface between the intermediate device and the device.

### BACKGROUND

The invention relates to a method for unlocking a function on a device. The invention also relates to an unlocking network for implementing the method, as well as a computer program.

License keys are usually required in order to unlock functions of a product using software. These keys are for sale and can often only be activated on one device. In this context, a specific unambiguous, unchangeable ID of the device is read to generate the license key therefrom, which can then only be validated on that device. A license server accessible on the internet can be used to automate this process.

Publication DE 10 2012 201 431 A1 discloses a method for licensing a plurality of software components on a data processing system, comprising the steps of retrieving a plurality of component-specific identification identifiers from the plurality of software components using a license management client installed on the data processing equipment, the bundle of the component-specific identification identifiers in a plant-specific licensing request by the license management client, sending the plant-specific licensing request from the license management client to a license management server associated with the license management client, extracting the component-specific identification identifier from the system-specific licensing request to generate component-specific licensing requests by the license management server, sending the component-specific licensing requests by the license management server to each of a plurality of licensing services, and receiving component-specific license keys from the plurality of licensing services to license the plurality of software components.

### SUMMARY

The object of the invention is a method for unlocking a function on a, an unlocking network, and a computer program having the features of the disclosure.

The object of the invention is a method for unlocking a function on a device. The device is in particular designed as and/or comprises a digital data processing device. In principle, the device can be designed as desired, so it is possible for the device to be implemented as a mobile and/or portable device. Alternatively, it is also possible that the device be designed as a stationary device. It is also conceivable that the device forms part of a vehicle or other mobile means.

The function on the device is in particular designed as a hardware and/or software function on the device.

In the method, an intermediate device and an unlocking arrangement are used to unlock the function on the device. The unlocking arrangement can in particular be arranged as a server and/or in the cloud. In particular, the unlocking arrangement is designed as a license server and/or as a license instance in the cloud.

The intermediate device is particularly preferably designed as a mobile and/or portable intermediate device. It is provided that the intermediate device comprising the unlocking arrangement uses a first communication link. In particular, the first communication link is designed as a secured communication link. For example, the communications link can be secured by using and/or exchanging digital keys to encrypt the transmitted data. For example, the first communication link uses an HTTPS protocol. Alternatively or additionally, the first communication link also uses email, SMS, proprietary protocols, or the like. In particular, the first communication link can be designed in a multi-channel manner, thus comprising a plurality of communication channels.

It is also provided that the intermediate device comprising the device uses a second communication link. In particular, the first and second communication links are designed to be independent of each other. In particular, a communication chain is formed by the first communication link and the second communication link. The intermediate device forms an intermediate point in the communication chain. The unlocking arrangement and the device are arranged at the ends of the communication chain.

The device exchanges the activation communication data with the unlocking arrangement via the first and the second communication link, in particular via the communication chain. The function is enabled on the device based on the exchanged unlock communication data. In particular, the device receives unlocking communication data, using which the function is enabled and/or validated.

In the context of the invention, it is proposed that the second communication link be achieved via an NFC interface. In particular, the device and the intermediate device are connected to each other through data technology via an NFC connection. In particular, the second communication link is designed in a single channel manner and/or is designed as an NFC channel, specifically exclusively as an NFC channel. The terms “NFC interface” and/or “NFC link”, and/or “NFC channel” are understood to mean an international transmission standard based on RFID technology for contactless exchange of data via electromagnetic induction using loosely coupled coils over short distances of a few centimeters and/or a data transfer rate of a maximum of 424 kBits/s. Communication between the device and the intermediate device can be both active-passive and active-active (peer-to-peer). NFC is an abbreviation for Near Field Communication.

In this context, is a consideration of the invention that some devices will not have a direct connection to the internet, or for example, have no corresponding user interface with which such a connection could be designed and used. Preferably, the device does not have a physical Ethernet or Wi-Fi connection and/or intentionally runs on an isolated network.

In these cases, the function on the device must thus be unlocked via detours, such as exchanging the relevant information by email, SMS, post, etc. However, this is a multi-step process that forces the customer to switch back and forth several times between a communication network having the unlocking arrangement, in particular a license arrangement, and the actual device. This procedure is tedious, prone to errors, and is also incomprehensible to non-cryptography experts.

In order to overcome these disadvantages, it is proposed according to the present invention that the second communication link be achieved via the NFC interface. An NFC interface is cost effective to implement, whereby authorization between the device and the intermediate device occurs by contacting it via the NFC interface. In particular, the second communication link is implemented without a login. Accordingly, the authorization is considered to be confirmed once the device and the intermediate device are brought close enough to establish the NFC link as the second communication link. Authentication of the second communication link is thus performed in particular by physical access to the device due to the use of NFC. Remote access is excluded due to the conditions of using NFC. Once the second communication link via the NFC interface has been established, the intermediate device can exchange all unlocking communication data between the device and the unlocking arrangement virtually as the intermediary for the device via the first communication link with the unlocking arrangement so that the function on the device can be enabled or enabled.

Therefore, the method for unlocking a function on a device does not require any further communication links other than the first communication link. It is thus simple to implement methods for unlocking the function on the device and also implement them in a cost-efficient manner by only using the NFC interface.

In a preferred embodiment of the invention, the unlocking is designed as an authorization and/or an activation, in particular as a license-based activation. Preferably, the unlocking is understood to refer to all authorization operations and/or activation operations that result in the unlocking and/or initial use of the function on the device.

It is preferred that the function be designed as a software function. In particular, software modules and/or software functions and/or software-supported libraries are unlocked through the unlocking. Alternatively or in addition, unlocking can also be the unlocking of a software-activatable hardware function or software-activatable hardware. For example, it is known in modern vehicles that certain hardware, such as headlights, air conditioning, etc., will be unlocked subsequently after purchase, based on a subscription model. Such hardware can, e.g., be unlocked via the method according to the invention.

In one particularly preferred implementation of the invention, the device is designed as an audio end amplifier and/or as an audio mix amplifier. In particular, the device forms a component in a sound system, e.g. for the output of music and/or speech at concerts, bars and clubs, restaurants, fitness clubs, opera houses, playhouses, stadiums, in particular sports stadiums, churches, etc.

The function, in particular the software function, is designed for instance as a particularly intelligent control unit on the audio end amplifier and/or audio mix amplifier. In the basic function, the audio end and/or mix amplifier provides the expected function, that is, to electrically amplify and mix the audio signals of a music or voice player in order to output them in a manner adapted to the speaker. The function is, e.g., designed as an unlockable module and in particular implemented as an intelligent control unit, thus enabling such a device to, e.g., be embedded in third-party media control systems in order to, e.g., use wall-mounted actuators and sensors to control audio levels during operation. Such audio end and/or mix amplifiers in particular typically do not have a connection to the internet, because they either do not have a physical Ethernet contact port or because they are intentionally operated in an isolated network.

In an alternative or further development of the invention, the function of the software function is designed as a maintenance function or a maintenance mode or an expert mode. Thus, for example, certain functions of the device can temporarily be unlocked as a function by the unlocking, for example certain maintenance, service and test modes for certain user groups such as service technicians and employees in (after sales) service, etc. Since an authentication is taking place, this can prevent untrained customers from gaining access to these modes, thereby accidentally damaging the device or unknowingly opening safety critical or vulnerable interfaces and or leaving them open to end users. In addition, this avoids a common practice in which cryptographically weak backdoors are installed in devices to unlock such functions, in particular service modules, accordingly.

In a particularly preferred and thereby simple implementation of the invention, the intermediate device is designed as a mobile, in particular a portable and/or handheld intermediate device. The intermediate device is designed as a smartphone in particular. In this embodiment, software for implementing the method as an application can, e.g., be loaded onto the intermediate device, in particular a smartphone, and installed there, whereby the intermediate device can act as a graphical user interface (human-machine interface) in controlling the exchange of the unlocking communication data.

It is particularly preferred that the authorization of the device is performed on the intermediate device or in the opposite direction is preferably performed only by contacting via the NFC interface. In particular, it is not necessary to enter further authorization information on the device, as authentication is performed by physical access, due to the NFC. This further simplifies the method for unlocking the function.

In a preferred implementation of the invention, the unlocking communication data comprise identity data and/or unlocking request data from the device, which are sent from the device to the unlocking arrangement via the intermediate device. The term “identity data” is, e.g., understood to mean an unambiguous device ID, such as the MAC address or the MCU ID. The term “unlocking request data” can, e.g., be understood to mean a request from the device defining the scope of the unlocking. The two types of data can also be summarized as installation IDs composed of a previously purchased license key and hardware features of the device. The license key defines the scope of the unlocking request data.

In a preferred further development of the invention, the unlocking communication data comprises unlocking authorization data, in particular a confirmation ID, which is transmitted from the unlocking arrangement to the device via the intermediate device. The unlocking authorization data are in particular designed as a response to the unlocking request data and/or identity data, in particular the installation ID. In particular, upon receipt of the unlocking request data, a check is conducted as to whether a corresponding license has been provided for the device and in particular purchased. If this is the case, the unlocking authorization data is sent to the device in response to the unlocking request data, which then imports it and in this way is able to unlock the authorized function.

In one preferred embodiment of the invention, the intermediate device receives activation data, in particular a license key, from the unlocking arrangement and transmits the data to the device. The activation data can be requested from the intermediate device, for example, by purchasing a license. After the transmission of the activation data to the device, the device can implement the unlocking request data, in particular the installation ID, based on the activation data.

A further object of the invention relates to an unlocking network comprising a license arrangement as previously described, an intermediate device as previously described, and a device as previously described, whereby the unlocking network is designed to implement the method as previously described.

A further object of the invention relates to a computer program having program code for implementing the method when the computer program is implemented on a digital data processing device and/or on the unlocking network.

### BRIEF DESCRIPTION OF THE DRAWING

Further features, advantages, and effects of the invention follow from the following description of a preferred exemplary embodiment of the invention, as well as the attached drawings. Shown are:

FIG. 1 a schematic diagram illustrating the method for unlocking a function on a device.

### DETAILED DESCRIPTION

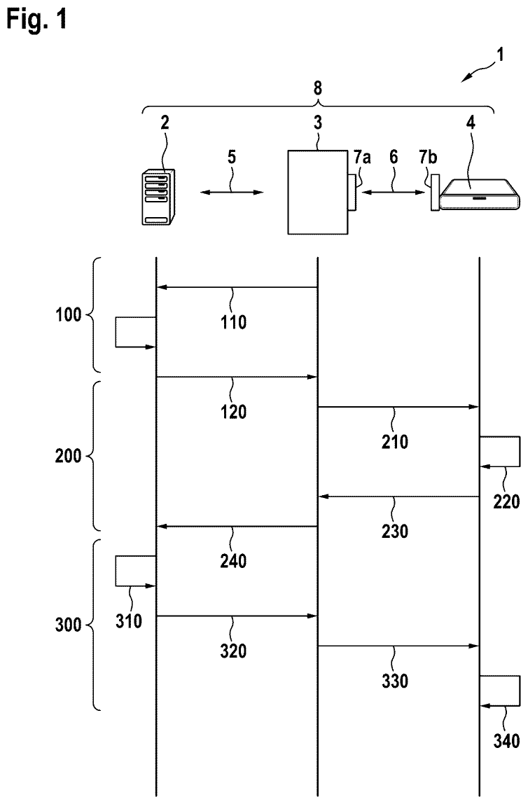

FIG. 1 shows an unlocking network 1 comprising an unlocking arrangement 2, an intermediate device 3, and a device 4 in the upper region. The unlocking arrangement 2 is, e.g., designed as a server, a website, a cloud, or the like. The intermediate device 3 is implemented as a handheld device, e.g. a smartphone. The device 4 can, e.g., implement the function of an audio end and/or mix amplifier. The device 4 is in particular not directly connected or cannot be connected to the unlocking arrangement 2.

A first communication link 5 can be established between the unlocking arrangement 2 and the intermediate device 3. For example, the first communication link 5 is designed as an internet connection and can be based on the HTTPS protocol. The first communication link can also be multi-channel and utilize other communication channels, such as SMS, email, etc.

The intermediate device 3 is connected to the device 4 via a second communication link 6, whereby the second communication link 6 is implemented via an NFC interface 7a, b. It can be provided that both the device 3 and the device 4 comprise an NFC interface 7a and 7b, which can enter into a communication contact with one another by moving close to the NFC interfaces 7a, b.

A communication chain 8 is formed by the first communication link 5 and the second communication link 6, whereby the terminals of the communication chain 8 are formed by the unlocking arrangement 2 and the device 4, and the intermediate device 3 forms an intermediate point in the communication chain 8. Unlocking communication data can be exchanged between the unlocking arrangement 2 and device 4 via the communication chain 8, and thus via the first communication link 5 and the second communication link 6, interfacing the intermediate device 3, so that one or more functions can be unlocked on the device 4. In particular, the functions on the device 4 are initially blocked or deactivated, whereby they are activated and/or authorized by the activation.

For example, the functions can be a media player module and/or a media library. However, the functions can also be designed as maintenance function, maintenance mode, and/or as an expert mode on or in the device 4.

The unlocking network 1 and/or the method has the advantage that device 4 can exchange the unlocking communication data while interfacing the intermediate device 3 with the unlocking arrangement 2, so the function can be activated on the device 4 without the use of further communication channels by the device 4, such as SMS, e-mail, etc. without any problems.

During unlocking, for example, an application is thus loaded onto the intermediate device 3, whereby the intermediate device 3 orders a license in a substep 110 from the unlocking arrangement 2 in licensing step 100. The unlocking arrangement 2 generates an activation ID and transmits it to the intermediate device 3 via the first communication link 5 in substep 120. The activation ID can be sent via email, for example, but the activation ID can also be downloaded from the intermediate device 3 and stored on the intermediate device 3 in connection with the application.

In step 200, based on the license or the activation ID, a request (request file) with identity data and/or unlocking request data, in particular an installation ID, is generated as unlocking communication data and transmitted to the unlocking arrangement 2 via the communication chain 8. In substep 210, the activation ID is imported into the device 4. In substep 220, the hardware function, identity data, and/or unlocking request data is generated based on the activation ID as a request (request file) or as an installation ID. The request is transmitted to the intermediate device 3 via the second communication link 6 in substep 230. In substep 240, the request is forwarded or transmitted to the unlocking arrangement 2 via the first communication link 5.

In step 300, a response (response file) is generated based on the request (request file), whereby the response comprises unlocking authorization data, in particular a confirmation ID. In substep 310, the response is generated based on the request. In substep 320, the response is downloaded from the unlocking arrangement 2 to the intermediate device 3. In substep 330, the response and thus the unlocking authorization data are loaded onto the device 4 by the intermediate device 3 via the second communication link 6. Finally, in substep 340, the unlocking authorization data activates the confirmation ID and the license (substep 110) in particular and enables the functions.

The method aims to completely automate the aforementioned process using a smartphone as the intermediate device 4, without having to connect the protected devices 4 to the internet. For this purpose, after purchasing the hardware and the license, the customer can, e.g., download a special application on their smartphone. These intermediate devices 3 are generally permanently connected to the internet via a mobile network or WLAN. The customer can thus authenticate themselves on the unlocking arrangement 2 designed as, e.g., a license server, and then hold the smartphone up to the purchased device 4 to initialize an NFC connection. The application can then execute the entire process above because there is a connection to both the license server and the licensed device 4.

The advantage is that the device 4 is not connected directly to the internet, but rather that certain, very restricted messages from the application are, e.g., translated from IPv4 to NFC. As a result, even the highest security requirements can be met because infecting the protected network can be considered as effectively impossible in this case, even if the smartphone used were affected by a hacker attack.

The same technique can also be used to temporarily activate certain functions of a device 4, e.g. certain maintenance, service and test modes, for certain user groups such as service technicians, or employees in (after sales) service. Since an authentication is taking place, untrained customers cannot gain access to these modes and thus accidentally damage the devices 4. The potential benefits include:
simple license and service activation
high security through the need for physical access for NFC
high security through online authentication without having to remove secured devices 4 from a secured network and (temporarily) embed them in an unsecured network
license unlocking for devices 4 without an IP/Ethernet connection.

1. A method for unlocking a function on a device (4) of a sound system,
wherein an intermediate device (3) comprising an unlocking arrangement (2) uses a first communication link (5) for communication,
wherein the intermediate device (3) comprising the device (4) uses a second communication link for communication,
wherein the device (4) comprising the unlocking arrangement (2) exchanges unlocking communication data via the first and the second communication links (5, 6) so that the function on the device (4) is unlocked,
the method comprising:
establishing the second communication link (6) via an NFC interface (7a, b) between the intermediate device (3) and the device (4).

2. The method according to claim 1, wherein the unlocking is designed as an authorization and/or an activation.

3. The method according to claim 1, wherein the function is designed as a software function or a software-activatable hardware function.

4. The method according to claim 1, wherein the device is designed as an audio amplifier and/or an audio mix amplifier.

5. The method according to claim 3, wherein the function is designed as a maintenance function, a maintenance mode, or an expert mode.

6. The method according to claim 1, wherein the intermediate device (3) is designed as a mobile device.

7. The method according to claim 1, wherein the authorization of the device (4) on the intermediate device (3) is performed by establishing contact via the NFC interface (7a, b).

8. The method according to claim 1, wherein the unlocking communication data comprise identity data and/or unlocking request data, which are transmitted from the device (4) to the unlocking arrangement (2) via the intermediate device (3).

9. The method according to claim 1, wherein the unlocking communication data comprises unlocking authorization data, which are transmitted from the unlocking arrangement (2) to the device (4) via the intermediate device (3).

10. The method according to claim 1, wherein the intermediate device (3) receives activation data from the unlocking arrangement (2) and transmits the data to the device (4).

11. An unlocking network (1) comprising:
an unlocking arrangement (2), an intermediate device (3) and a device (4), wherein the unlocking network (1) is configured to implement the method according to claim 1.

12. A non-transitory computer-readable medium comprising instructions that executed by a computer cause the computer to unlock a function on a device (4) of a sound system,
wherein an intermediate device (3) comprising an unlocking arrangement (2) uses a first communication link (5) for communication,
wherein the intermediate device (3) comprising the device (4) uses a second communication link for communication,
wherein the device (4) comprising the unlocking arrangement (2) exchanges unlocking communication data via the first and the second communication links (5, 6) so that the function on the device (4) is unlocked,
by:
establishing the second communication link (6) via an NFC interface (7a, b) between the intermediate device (3) and the device (4).
